(19) United States
(12) Patent Application Publication
(10) Pub. No.: US 2025/0112009 A1
(43) Pub. Date: Apr. 3, 2025

(54) Clicking Key Switch

(71) Applicant: Glorious LLC, Austin, TX (US)

(72) Inventor: Nicholas J. Bitetto, East Northport, NY (US)

(73) Assignee: Glorious LLC, Austin, TX (US)

(21) Appl. No.: 18/477,830

(22) Filed: Sep. 29, 2023

(51) Int. Cl. H01H 13/85

(52) U.S. Cl. CPC H01H 13/85; H01H 2215/03

(57) ABSTRACT

A key switch for computer keyboards that generates a clicking sound when pressed and released. Embodiments of the key switch include a housing, a stem, a position spring, a torsion spring, and a click bar. The stem flexes the torsion spring when the key switch is depressed, and after reaching a predetermined threshold, the torsion spring contacts the click bar producing a first click sound. When the key switch is released, the torsion spring contacts the click bar a subsequent time producing a second click sound of equal volume with the first click sound.

### FIELD OF THE DISCLOSURE

The present disclosure generally relates to a computer accessory, and more particularly to a replaceable switch for a computer keyboard.

### BACKGROUND

Keyboards serve an essential function in many jobs and hobbies. With the increasing prevalence of computers in a variety of jobs, positions, and hobbies, keyboards have become an essential tool in the office and home. As keyboards have become more important, more options to customize keyboards from the look, tactile feel, response time, typing sound, and more have emerged.

In customization, the most common way to create a keyboard that can be adjusted for each user is to use various kinds of key switches. Key switches are part of the key that both registers the key press and also work to return the key to a resting position. For example, the tactile feedback may be varied by high or low triggering position between an elastic piece and a conductive electrode, long or short travel distance, required actuation force of the key switch, actuation points for the key switch, tactile or linear feedback of the key switch, clicky or non-clicky tactile feedback of the key switch, etc. A conventional mechanical key switch only provides one single kind of tactile feedback without any tactile feedback adjusting function. Beyond the tactile feel of the keys on a keyboard, different office and home situations may require different levels of sound from a keyboard. While some users desire a quiet keyboard that makes little or no sound, a market has emerged for keyboards with a satisfying click sound when the keys are pressed. Different companies have addressed this in different ways with some using click plates and others using springs. One pitfall users may find in the current market of clicking key switches is switches that click only when pressed, or switches that tout a dual click feature, but have an inconsistent second click or a second click so quiet it cannot be heard.

### SUMMARY

Embodiments of the present disclosure include a key switch for a computer accessory for use as an input device of a computer that comprises a switch housing, a stem, a position spring positioned under the stem, a torsion spring, and a click bar, wherein the portion of the torsion spring that is positioned under the click bar contacts the click bar when the stem is depressed, resulting in a first click sound, and the portion of the torsion spring that is positioned under the click bar contacts the click bar a subsequent time when the stem is released, resulting in a second click sound. In embodiments, the stem extends above the switch housing, the position spring returns the stem to a starting position, and the torsion spring makes a click sound when acted upon by the stem, wherein the click bar is positioned over a portion of the torsion spring.

Embodiments of the present disclosure also include a key switch for a computer accessory for use as an input device of a computer that comprises a switch housing, a stem, a torsion spring, and a click bar, wherein a portion of the torsion spring that is positioned under the click bar contacts the click bar when the stem is depressed, resulting in a first click sound, and the portion of the torsion spring that is positioned under the click bar contacts the click bar a subsequent time when the stem is released, resulting in a second click sound. In embodiments, the stem extends above the switch housing, a portion of the torsion spring extends outside a top portion of the switch housing, and the click bar is positioned over the portion of the torsion spring outside of the top portion of the switch housing.

### BRIEF DESCRIPTION OF THE DRAWINGS

For a more complete understanding of this disclosure, reference is now made to the following description, taken in conjunction with the accompanying drawings, in which:

FIG. 1 depicts a perspective view of a key switch according to an embodiment of the present disclosure;

FIG. 2 depicts an exploded view of a key switch according to an embodiment of the present disclosure;

FIG. 3 depicts a perspective view of a key switch with a top portion of a housing removed according to an embodiment of the present disclosure;

FIG. 4A depicts a perspective view of a stem of a key switch according to an embodiment of the present disclosure; and

FIG. 4B depicts a perspective view of a torsion spring of a key switch according to an embodiment of the present disclosure.

FIG. 4C depicts a profile view of a click bar of a key switch according to an embodiment of the present disclosure.

### DETAILED DESCRIPTION

The present disclosure describes embodiments of a key switch for use with a computer accessory, such as a keyboard, for use as input for a computer. In embodiments, the key switch has a housing, a stem, a position spring, a torsion spring, and a click bar. The click bar is positioned over a portion of the torsion spring. When the stem is depressed, a portion of the stem comes into contact with the torsion spring, and the stem flexes the torsion spring in a downward manner. Once the stem reaches a predetermined threshold, the torsion spring is released and comes into contact with the click bar creating a first clicking sound. When the stem is released, the portion of the stem comes into contact with the torsion spring and flexes the torsion spring in an upwards direction. Once the stem reaches a predetermined threshold, the torsion spring releases and comes into contact with the click bar creating a second clicking sound.

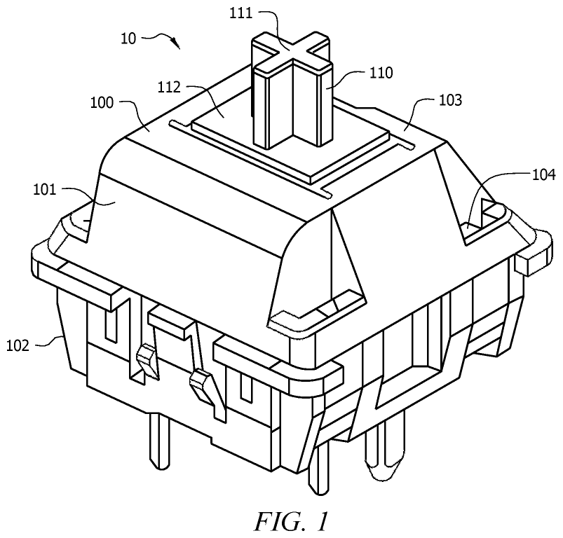

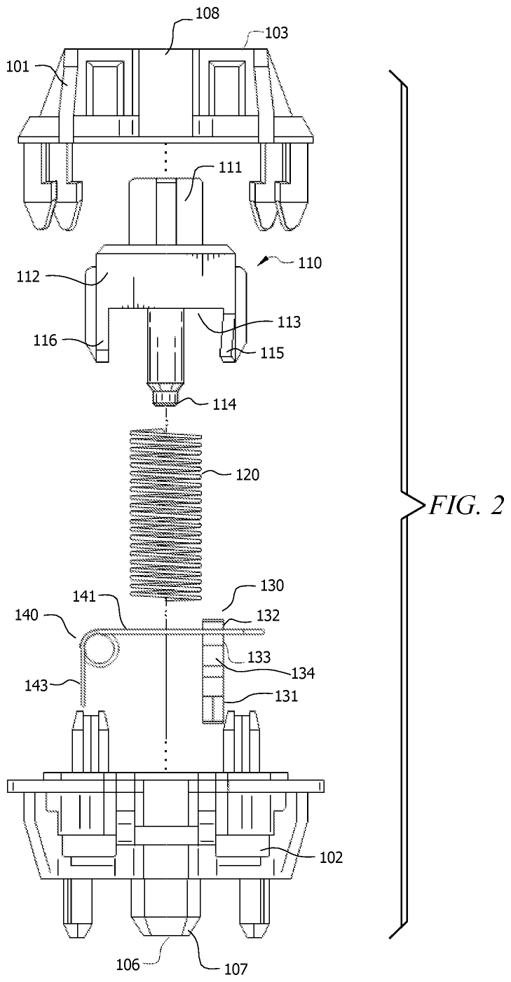

FIGS. 1 and 2 depict a perspective view and an exploded view respectively of a key switch 10. While FIG. 2 shows the minimum components needed for the key switch 10, other components can be included without departing from the present disclosure. Components such as lights, weights, O-rings, switch films, spring weights, lubricants and other components used to customize key switches are all considered and can be used with the disclosed key switch 10. In embodiments, key switch 10 has a housing 100, a stem 110, a position spring 120, a click bar 130, and a torsion spring 140. When the stem 110 is depressed, it causes the torsion spring 140 to come into contact with the click bar 130 generating a first clicking sound. When the stem 110 is released, it again causes the torsion spring 140 to come into contact with the click bar 130 generating a second clicking sound. In this way the key switch 10 generates a consistent clicking sound when the key switch is pressed and when the key switch is released. A plurality of key switches 10 can be used to form a mechanical keyboard with consistent two-click functionality. The key switch 10 can be hot-swapped into and out of a mechanical keyboard allowing a user to customize which of their keys has the dual click functionality.

In embodiments, the housing 100 of the key switch 10 is formed of two portions, an upper portion 101 and a lower portion 102. In embodiments, the housing 100 is hollow and keeps all other components of the key switch 10 in place. The other components of the key switch 10 are at least partially contained in the housing 100. In embodiments, the housing 100 also allows the key switch 10 to be removable, or hot-swappable, from one portion of a keyboard to another portion of the same keyboard, or a different keyboard. The key switch 10 is able to have all the components in the housing 100 to connect and function with a variety of different keyboards as long as the different keyboards have the same hot-swap connectors. The upper portion 101 of the housing 100 connects to the lower portion 102 of the housing 100. In some embodiments, the upper portion 101 and the lower portion 102 snap together to form the housing 100. The upper portion 101 and the lower portion 102 can be removably joined to allow a user to open the housing 101 to add, adjust, or change the components in the housing 100 to further customize the key switch 10. The upper portion 101 and lower portion 102 can be removably connected with tabs and connectors, screws, magnets, hinges, and combinations thereof. In other embodiments, the upper portion 101 and the lower portion 102 are formed as one piece or permanently sealed together to form one piece. The upper portion 101 and lower portion 102 can be permanently sealed using glue, resin, melting the pieces together, adhesives, and combinations thereof.

In embodiments, the upper portion 101 has at least an opening 108 for the stem 110 to extend above a top surface 103 of the upper portion 101. The upper portion 101 can also have additional openings 104 that can be used to reduce weight, allow access to components, not block the clicking sound, increase airflow, and combinations thereof. The additional openings 104 can be disposed around the opening 108 for the stem 110. The additional openings 104 can be on different surfaces of the upper portion 101 to best accommodate the intended purpose. Different embodiments of the upper portion 101 can include components such as lights. In these embodiments, transparent material can be placed over the additional openings 104 to allow for the light to appear as different colors. The upper portion 101 can be made of a transparent material to allow any light to travel from below or within the key switch 10 through the housing 100 and to illuminate a keycap that may be used with the key switch 10.

In embodiments, the lower portion 102 of the housing 100 has at least one opening 106. The at least one opening 106 allows the stem 110 and one or more contact pins to extend below a bottom surface 107 of the lower portion 102. In embodiments, the lower portion 102 acts as an inner bottom surface to the key switch 10 and holds many of the other components of the key switch 10, such as the stem 110, positional spring 120, click bar 130, and torsion spring 140. The lower portion 102 can have a different shape from the upper position 101. In some embodiments, the lower portion 102 extends further in one or more directions than the upper portion 101 so that the click bar 130 and the torsion spring 140 are held by the lower portion 102 but not covered by the upper portion 101 to allow for less material blocking the clicking sounds. The lower portion 102 can also be made of a transparent material to allow any light to travel from below or within the key switch 10 to travel through the housing 100 to illuminate the base of the keyboard to which the key switch 10 is attached. The housing 100 can be made from polycarbonate, nylon, aluminum, acrylic, polyethylene, polyamide, polyoxymethylene (POM), Acrylonitrile Butadiene Styrene (ABS), or combinations thereof.

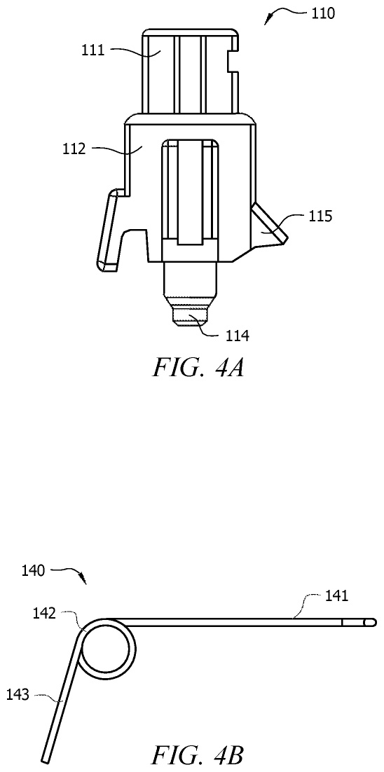

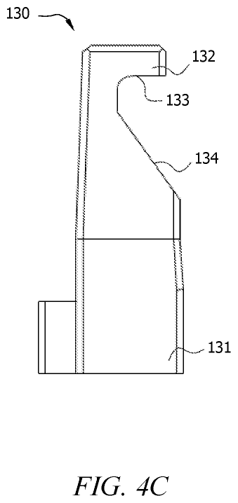

The stem can be seen in FIGS. 1, 2, and 3, but is shown in more detail in FIG. 4A. In embodiments, the stem 110 extends through a center 108 of the housing 100. The stem 110 has a connector portion 111, a body portion 112, a contact portion 114, and a trigger portion 115. In embodiments, the connector portion 111 extends above the top surface 103 of the upper portion 101 of the housing 100. The connector portion 111 can be shaped to connect to one or more different keycaps and can be sized such that keycaps can connect with the connector portion 111 without being loose. Different keycaps produced by different companies can have different portions to connect to key switches. The connector portion 111 can be designed to mate with one specific type of keycap or can be designed to mate with a large variety of keycaps allowing the key switch 10 to be used with a larger variety of keycaps produced by different companies. In some embodiments, the connector portion 111 is removable to allow the user to attach a connector portion that is needed to mate to the specific keycap that is desired by a user.

In embodiments, the body portion 112 provides stability to the stem 110 and secures the stem 110 within the housing 100. Different embodiments of the key switch 10 can have a body portion 112 with different shapes. In embodiments, the body portion 112 has one or more feet 116 that extend downward from the body portion 112 and determine how far down the stem 110 can be pressed. As the stem is pressed down, the one or more feet come into contact with the lower portion 102 of the housing 100 stopping the stem 110 from being pressed any further. Different embodiments of the body portion 112 can be designed to allow for more or less distance for pressing the switch, creating a different feel for the key switch 10. The different shapes can accommodate lighter key switches, additional lights, additional effects, additional components, different housing shapes, and combinations thereof. The different shapes can be solid to provide more weight or heft to the stem, be hollow to allow additional components to fit in the housing 100, or hybrid models that work to achieve a balance desired by the intended audience whether that be working professionals or avid gamers. Different embodiments of the key switch 10, stem 110, and body portion 112 can all utilize the double click system to provide a key switch that provides all the features desired by consumers.

In embodiments, the contact portion 114 contacts the printed circuit board (PCB), or other electronic medium, sending a signal that the key has been pressed. The contact portion 114 can include a variety of different materials that will contact the PCB, or other electronic medium, depending on the electronic medium, and the type of signal being sent. In embodiments, the contact portion 114 is connected to a lower side 113 of the body 112. Different embodiments of the contact portion can be different lengths based on the shape and size of the body portion 112 as well as the distance between the key switch 10 and the PCB or other electronic medium for the specific keyboard that the key switch 10 is being used with. In the same or alternative embodiments, there are a plurality of contact portions that contact the PCB. In some embodiments, body 112 does not include a contact portion 114. Instead, key switch 10 can include a separate component that moves in conjunction with the stem 110 to contact the PCB when a key is pressed. For example, embodiments of key switch 10 can include a “leaf” comprising one or more contact portions or pins that contact the PCB when a key is pressed. In these embodiments, when the stem 110 is depressed, it presses the leaf and the corresponding one or more pins into the PCB to signal that a key has been pressed. The leaf can rest within the lower portion 102 of the housing 100 or be connected to the stem 110.

In embodiments, the trigger portion 115 is connected to the stem 110. The trigger portion extends away from the stem 110 and towards the torsion spring 140. The trigger portion 115 flexes the torsion spring 140 downwards or upwards depending on the direction the stem 110 is moving to cause the clicking sounds. In different embodiments, the trigger portion 115 can be connected to an outside of the body portion 112, the connector portion 111, the contact portion 114, or combinations thereof. The trigger portion 115 can be connected to the different portions of the stem 110 in different embodiments depending on the shape of the body portion 112 and the lower portion 102 of the housing. Different embodiments of the lower portion 102 of the housing 100 can place the click bar 130 and the torsion spring 140 in different locations. In embodiments, the trigger portion 115 is connected to the portion of the stem 110 that allows the trigger portion 115 to flex the torsion spring 140 while still releasing it at the predetermined threshold and not before or after. The stem 110 can be made from polycarbonate, nylon, aluminum, acrylic, polyethylene, polyamide, polyoxymethylene (POM), Acrylonitrile Butadiene Styrene (ABS), or combinations thereof. In different embodiments, each portion of the stem 110 can be made of a different material. Embodiments can select the best material for each portion allowing for a stronger, lighter, more durable stem, or some combination of traits.

In embodiments, the position spring 120 surrounds the connector portion 111, the contact portion 114, and combinations thereof. The position spring 120 returns the stem 110 to an extended position after it is pressed. In embodiments, the position spring 120 is connected to the lower portion 102 of the housing 100. In other embodiments, the position spring 120 is connected to a lower side 113 of the body portion 112 of the stem 110. The different embodiments can depend on the size of the spring, length of the stem 110, shape of the housing 100, and combinations thereof. In different embodiments, different heights, materials, and strengths of spring can be used to affect the feel and resistance of the key switch 10 during use. Other embodiments allow the position spring 120 to be swapped or adjusted so the user can customize the feel of the key switch 10 to their desire. Still other embodiments can use a plurality of position springs 120 located in locations under the stem 110 while not being positioned around the connector portion 111 or the contact portion 114. The position spring 120 can be made of stainless steel, brass, phosphor bronze, oil tempered wire, hard drawn MB, music wire, steel alloy, high-carbon steel, copper alloy, nickel alloy, and combinations thereof.

In embodiments, the click bar 130 is a separate component of the key switch that rests near the body portion 112 of the stem 110. In some embodiments, the click bar 130 is inside of the housing 100, and in other embodiments, portions of the click bar 130 can be outside of the housing 100. In embodiments, the click bar 130 has a lower portion 131 and an overhang 132. The lower portion 131 can rest near or against the body portion 112, and in some embodiments it can rest on the lower portion 102 of the housing 100. In embodiments, the lower portion 131 secures the click bar 130 in the key switch 10. In some embodiments, the lower portion 131 is affixed to the body portion 112. In other embodiments, the lower portion 131 is not affixed to the body portion 112, but the shape of the body portion 112 is configured to hold the click bar 130 generally in position with only slight movement by the click bar 130. The movement allowed by the body portion 112 aids in the audible and consistent two click sound of the key switch 10.

In embodiments, the overhang 132 extends around and over the torsion spring 140 and is the surface that the torsion spring 140 contacts to generate the click sounds. Some embodiments of the overhang 132 can be shaped similarly to a C, while other embodiments can be shaped similarly to an upside-down L. In embodiments, the overhang 132 contacts the torsion spring 140 once the torsion spring 140 has been released. In these embodiments, the torsion spring 140 contacts a lower side 133 of the overhang 132, which generates an audible click sound. In other embodiments, the torsion spring travels downwards and contacts an upper side 134 of the lower portion 131. The torsion spring contacts the upper side 134 and then returns to a starting position, contacting the lower side 133 of the overhang 132 to generate a second audible click sound. Embodiments in which the click bar 130 is separate from the stem 110 and/or the housing 100 allow the contact from the torsion spring 140 to create a louder, more distinct clicking sound. The click bar 130 being a separate feature also allows the clicking sound to be more consistent than if an overhang was part of the stem 110 or housing 100. If the click bar 130 was part of the housing 100, the material of the housing 100 could absorb some of the shock from the contact made by the torsion spring 140, lessening the click sound as the shock is distributed throughout the whole housing 100. Other key switches have attempted to use click plates or click jackets to make an audible click sound only on the key's downstroke. Click plates or jackets are more susceptible to misfiring or making a quieter clicking sound. To ensure the click plate or jacket is only contacted when a key was pressed, it is often placed closer to the center of the key switch, which allows the housing to further muffle and deaden the click sound. Embodiments of the click bar 130 avoid these pitfalls by making the click bar 130 a separate element of the key switch 10 that is able to consistently generate two click sounds for each key press. The click bar 130 can be made from polycarbonate, nylon, aluminum, acrylic, polyethylene, polyamide, polyoxymethylene (POM), Acrylonitrile Butadiene Styrene (ABS), or combinations thereof. The lower portion 131 and the overhang 132 can be made of the same or different materials.

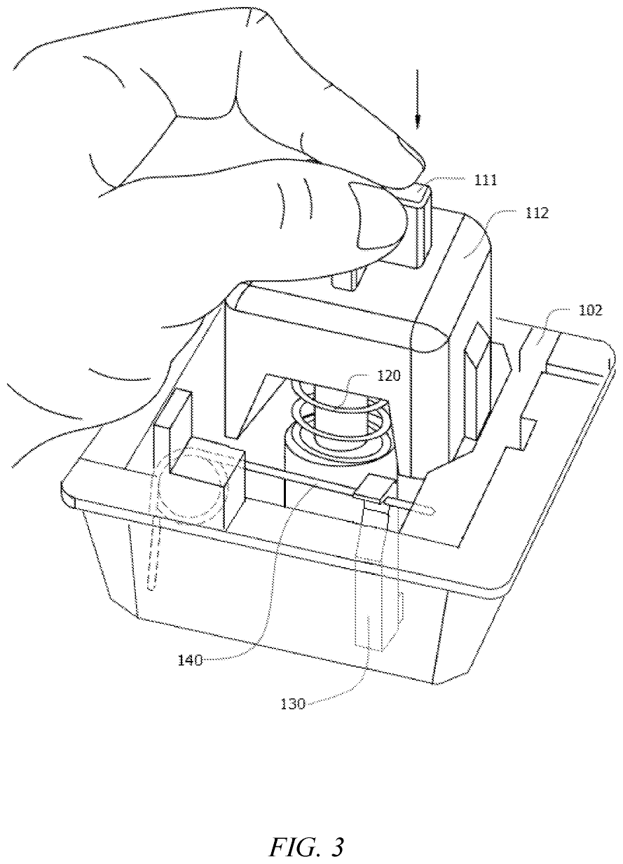

The torsion spring in FIGS. 2 and 3 is depicted in more detail in FIG. 4B. The torsion spring 140 is flexed to provide the clicking sounds for the key switch 10. Embodiments of the torsion spring 140 have a click portion 141, a spring portion 142, and an anchor portion 143. In embodiments, the click portion 141 is positioned under the overhang 132 of the click bar 130. The click portion 141 is acted upon by the trigger portion 115 of the stem 110. When the stem 110 is pressed, the trigger portion 115 travels in a downward motion and contacts the click portion 141 of the torsion spring 140. The trigger portion 115 begins pushing the click portion 141, flexing the click portion 141 in a downward direction. As the click portion 141 flexes, the spring portion 142 becomes taught. At a predetermined threshold, the trigger portion 115 releases contact with the click portion 141, and the spring portion 142 acts upon the click portion 141 to return to an original position. As the click portion 141 returns to the original position, the click portion 141 contacts with the click bar 130 producing the first click sound. In embodiments, the predetermined threshold can be an actuation point, a reset point, an arbitrary point, the lowest point the stem 110 can reach, an adjustable point, or combinations thereof. In embodiments, the predetermined threshold is based on the shapes of the click bar 130 and trigger portion 115. For example, as the trigger portion 115 pushes the click portion 141 downward into the sloped upper side 134 of the lower portion 131, the click portion 141 is pushed horizontally away from the stem and trigger portion 115 until the click portion 141 separates from the bottom of trigger portion 115. The predetermined threshold could therefore be modified, for example, by altering the slope of the upper side 134 of the lower portion 131 and/or altering the horizontal width of trigger portion 115.

When the stem 110 is released, the trigger portion 115 travels in an upward motion. The trigger portion 115 contacts the click portion 141 of the torsion spring 140. The trigger portion 115 begins pushing the click portion 141, flexing the click portion 141 in an upward direction. As the click portion 141 flexes, the spring portion 142 becomes taught. At a predetermined threshold, the trigger portion 115 releases contact with the click portion 141, and the spring portion 142 acts upon the click portion 141 to return to the original position. As discussed above, in embodiments, the predetermined threshold is based on the shapes of the click bar 130 and trigger portion 115. As the click portion 141 returns to the original position, the click portion 141 contacts the click bar 130 producing the second click sound. In embodiments, the spring portion 142 provides a tactile feel to the use of the key switch 10. As the stem 110 begins to flex the click portion 141, the spring portion 142 provides resistance as the spring portion 142 attempts to return the click portion 141 to the original position. Once the stem 110 reaches the predetermined threshold and the click portion 141 is released, the movement of the stem 110 becomes easier, providing a tactile feel for the user of an actuation point of the key switch 10. Different torsion springs 140 with different strength spring portions 142 can be used in different embodiments to provide different tactile feel to the use of the key switch 10. Different strength spring portions 142 can also change the volume of the click sounds. The tighter and stronger the spring strength, the faster the click portion 141 can be returned to the original position, and the faster the click portion 141 is moving, the louder the resulting click will sound. In embodiments, the anchor portion 143 of the torsion spring 140 is connected to the housing 100 to ensure that when the click portion 141 is being acted upon, the torsion spring 140 does not shift positions. The torsion spring 140 can be made of stainless steel, brass, phosphor bronze, oil tempered wire, hard drawn MB, music wire, steel alloy, high-carbon steel, copper alloy, nickel alloy, and combinations thereof.

FIG. 3 depicts a perspective view of a key switch with the upper portion 101 of the housing 100 removed. Embodiments of the lower portion 102 of the housing 100 have a cavity that accepts the torsion spring 140 and the click bar 130. In embodiments, the cavity has positions to accept the lower portion 131 of the click bar 130 and the anchor portion 143 of the torsion spring 140. The cavity provides room for the torsion spring 140 to move and flex as required to make the clicking sounds without interference from other components of the key switch 10. In embodiments, the cavity is shaped with acoustics in mind to reverberate the clicking sounds up and out towards the user, further allowing the clicking sounds to be distinct and consistent. This includes room for the torsion spring 140 to flex without coming into contact with the lower portion 102 of the housing 100. In embodiments, the cavity is positioned so the torsion spring 140 and click bar 130 are positioned under one or more of the additional openings 104 of the upper portion 101.

The terminology used above may be interpreted in its broadest reasonable manner, even though it is being used in conjunction with a detailed description of certain specific examples of the present disclosure. Indeed, certain terms may even be emphasized above; however, any terminology intended to be interpreted in any restricted manner will be overtly and specifically defined as such in this Detailed Description section. Both the foregoing general description and the detailed description are exemplary and explanatory only and are not restrictive of the features, as claimed.

As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus.

In this disclosure, relative terms, such as, for example, “about,” “substantially,” “generally,” and “approximately” are used to indicate a possible variation of ±10% in a stated value.

The term “exemplary” is used in the sense of “example” rather than “ideal.” As used herein, the singular forms “a,” “an,” and “the” include plural reference unless the context dictates otherwise.

Although the present disclosure and its advantages have been described in detail, it should be understood that various changes, substitutions, and alterations can be made herein without departing from the spirit and scope of the disclosure. Moreover, the scope of the present application is not intended to be limited to the particular embodiments described in the specification. As one of ordinary skill in the art will readily appreciate substitutions presently existing or later developed that perform substantially the same function or achieve substantially the same result as the corresponding embodiments described herein may be utilized according to the present disclosure.

What is claimed is:

1. A key switch for a computer accessory for use as an input device of a computer comprising:
a switch housing;
a stem, wherein a portion of the stem extends above the switch housing;
a position spring positioned under the stem, wherein the position spring is configured to return the stem to a starting position after the stem is depressed;
a torsion spring, wherein the torsion spring is configured to make a click sound when acted upon; and
a click bar, wherein an overhang of the click bar is positioned over a portion of the torsion spring;
wherein the portion of the torsion spring that is positioned under the overhang contacts the click bar when the stem is depressed resulting in a first click sound, and the portion of the torsion spring that is positioned under the overhang contacts the click bar a subsequent time when the stem is released resulting in a second click sound.

2. The key switch of claim 1, wherein when the stem is depressed, the torsion spring flexes in a downward direction, and when the stem passes a predetermined threshold, the portion of the torsion spring under the overhang will release and contact the click bar producing the first click sound.

3. The key switch of claim 2, wherein when the stem is released, the torsion spring flexes in an upward direction, and when the stem passes the predetermined threshold, the portion of the torsion spring under the overhang will release and contact the click bar producing the second click sound.

4. The key switch of claim 1, wherein the first click sound and the second click sound are of equal volume.

5. The key switch of claim 1, wherein a portion of the torsion spring extends outside a top portion of the switch housing.

6. The key switch of claim 5, wherein the portion of the torsion spring that extends outside the top portion of the housing is the portion of the torsion spring that is under the overhang.

7. The key switch of claim 1, wherein the click bar is not connected to the stem.

8. The key switch of claim 1, wherein the housing comprises an upper portion and a lower portion, and wherein the click bar is not connected to the upper portion.

9. The key switch of claim 8, wherein the click bar is not connected to the stem.

10. The key switch of claim 8, wherein the upper portion comprises an opening for the stem and one or more additional openings, wherein the one or more additional openings are configured to permit the first click sound and the second click sound to emanate through the one or more additional openings.

11. The key switch of claim 8, wherein at least a portion of the click bar is outside of the upper portion.

12. The key switch of claim 1, wherein the key switch is hot-swappable.

13. The key switch of claim 1, wherein the portion of the torsion spring that is positioned under the overhang contacts the overhang to make the first click sound.

14. The key switch of claim 13, wherein the portion of the torsion spring that is positioned under the overhang contacts the overhang to make the second click sound.

15. The key switch of claim 1, wherein the click bar is shaped like an upside-down letter L.

16. The key switch of claim 1, wherein the click bar is shaped like a letter C.

17. The key switch of claim 1, wherein the click bar comprises a sloped lower portion, and when the stem is depressed, the portion of the torsion spring that is positioned under the overhang is pushed downward against the sloped lower portion.

18. The key switch of claim 17, wherein the sloped lower portion of the click bar pushes the portion of the torsion spring that is positioned under the overhang horizontally away from the stem.

19. The key switch of claim 17, wherein when the stem is released, the portion of the torsion spring that is positioned under the overhang pushes upward against the bottom of the overhang.

20. The key switch of claim 1, wherein the click bar is made from nylon.
